(19) United States
(12) Patent Application Publication
(10) Pub. No.: US 2014/0091925 A1
(43) Pub. Date: Apr. 3, 2014

(54) Backseat Safety Alarm

(71) Applicant: Christina Luder Moody, Houston, TX (US)

(72) Inventor: Christina Luder Moody, Houston, TX (US)

(21) Appl. No.: 14/041,005

(22) Filed: Sep. 30, 2013

Related U.S. Application Data
(60) Provisional application No. 61/708,831, filed on Oct. 2, 2012.

(51) Int. Cl. G08B 21/24; G08B 21/02

(52) U.S. Cl. CPC G08B 21/24; G08B 21/02
USPC 340/539.11; 340/539.1

(57) ABSTRACT

The disclosure teaches a two component system for ensuring persons (such as infants), objects or animals are not unintentionally left unattended in parked cars. The system requires the driver (custodian) to activate a first component that emits a radio signal. The radio signal is received by a second component. The second component may be attached to the custodian's ignition key chain. The radio signal has limited range. If the custodian walks away from the car or first transmitting component without first disabling the first component, an alarm will illuminate or sound. The system may also be used with other devices such as shopping carts. It may also be used to monitor movement of disabled individuals.

### RELATED APPLICATIONS

This Application claims priority to provisional application Ser. No. 61/708,831 filed Oct. 2, 2012 and entitled Backseat Safety Alarm which is incorporated by reference in its entirety herein.

### BACKGROUND OF INVENTION

1. Field of Use

The disclosure pertains to an alarm system using a transmitter and receiver to guard against persons, including but not limited to babies or infants, objects or animals being inadvertently left in a car.

2. Prior Art

Issued patents and published patent applications exist disclosing various systems and alarms intended to prevent babies or infants being accidently left unattended in cars. Included is the application of David R. Quinonez, application Ser. No. 10/033,608 filed Jan. 2, 2002. The Quinonez disclosure teaches an alarm component activated by latching a child safety seat harness.

### SUMMARY OF DISCLOSURE

The Applicant's disclosure consists of two components. The first is a radio signal transmitter component. The system can be activated by turning on the radio signal transmitter component (hereinafter “first component”). The first component may be battery operated. It may be attached to a child's car seat or seat belt strap. It will be appreciated that the attachment point not be accessible to the infant who may accidently turn the system off. It may be utilized without attachment. In one embodiment, the first component may be controlled from the second component (discussed below). The first component continuously transmits a low power radio signal.

The radio signal is detected by a second component. The second component may be battery operated. The second component also includes one or more alarms. The second component can be attached to a driver's key ring such as a key ring attached to a car ignition key.

The second component is activated by receipt of the radio signal from the first component. As stated previously the radio signal is transmitted continuously. If there is a break in the radio signal received by the second component, an alarm sounds in the second component. In another embodiment, the radio signal is transmitted at predetermined intervals. The second component can be programmed to accept the timed breaks in receipt of a radio signal as acceptable non-interruption and no alarm is sounded.

In one embodiment, if there is a break in the radio signal received by the second component from the first component, an alarm will sound in the second component. The second component includes an audible speaker operating in communication with a control subcomponent. The control subcomponent is also in communication with the radio signal receiver. The control subcomponent activates the speaker when there is an interruption in the receipt of the radio signal. In an alternative embodiment discussed above, the control subcomponent activates the alarm speaker only if the signal interruption exceeds a predetermined duration. It will be appreciated that the programmed radio transmissions will save energy and battery life.

The radio signal receiver, antenna, battery, alarm speaker and control subcomponent may be contained within a housing of the second component. The radio signal transmitter, the activation switch and battery of the first component may be contained in a housing of the first component. The first component housing may contain a spring loaded clip or similar fastening device to attach the housing to the car seat, seat belt strap or other structure. In other embodiments, the first component may be designed to sit on a car seat. The design may incorporate a roughened housing surface to eliminate the component sliding off the seat. In another embodiment, the housing may have an enlarged planar surface to make the housing visible. In another embodiment, the housing can be a bright color. In another embodiment, the housing can have a light. In yet another embodiment the light may flash on and off.

The first component may be portable. It may be removed from the seat by the driver at the same time the infant is removed from the car seat. This may eliminate the need to deactivate the first component since it will remain in proximity to the second component (for example on the key chain). The first and second component are available for use in a second location. For example it may be used in conjunction with a shopping cart. The alarm will sound if the custodian wanders too far from the shopping cart holding the infant.

Interruptions activating the alarm are intended to be interruptions in the receipt of the radio signal from the first component. This interruption of signal may be from various causes but is primarily envisioned to be caused by the second component moving outside the range of the first component radio signal transmitter. This can occur when the driver turns off the car engine, removes the keys from the transmission (including the second component) and exits the car. The radio signal, being low power, does not reach the receiver beyond a few feet. The second component, carried by the driver, sounds an alarm. This audible alarm alerts the driver that someone or something has been left in the car.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates the logic flow of the control subcomponent.

FIG. 2 illustrates the spatial relationship of the operation of the device.

### DETAILED DESCRIPTION OF DISCLOSURE

The operation of the alarm system includes a driver (sometimes referred to herein as a “custodian”) a “passenger” (including but not limited to an infant, child or adult) or an animal such as a police dog, rescue dog or pet. The passenger may also be an object, including but not limited to a lap top computer, tablet computer or a smart phone. It is envisioned that an adult passenger may be disabled.

The system includes a first component and a second component. The first component is a radio signal transmitter. The radio transmitter can be of the type subject of FCC ID SQR-CL305S. The first component may be attached to a passenger seat such as a child car seat. The first component can have a clip or other detachable attachment subcomponent. In another embodiment, the first component may be shaped to sit securely on the surface of the car passenger seat or on the shelf behind the rear seat back. The first component may include a covering or textured housing to retard the component from sliding across the seat surface and onto the car floor. The textured surface may also prevent the first component from sliding off the carpeted or fabric covered shelf behind the rear seat back. In another embodiment, the first component may be used with a hook and loop device. For example a strip containing loops could be adhesively attached to a car seat or seat belt strap. The first component could contain the complementary hook attachment strip. The first component could be attached to the seat belt strap or car seat surface. In another embodiment, the first component could be worn by the passenger. This could be as a wrist strap. As discussed below, the first component may not contain an on/off switch but rather is controlled by the second component.

The first component may have a control switch controlling the radio transmitter. The controller may control the effective range of the transmitter. The controller may adjust the radio signal frequency. The first component may contain battery powering subcomponent.

The system also consists of a second component. The radio signal transmitted by the first component is detected or received by the second component. The second component may be battery operated. The second component also includes one or more alarms or sound devices. The second component can be attached to a driver's (custodian's) key ring such as a key ring attached to a car ignition key.

A control subcomponent for the second component may be contained within the housing of the second component (which may be attached to the driver's key chain). The control subcomponent may be programmable. Alternatively its settings may be fixed. The control subcomponent interfaces between radio signal receiver and the device alarm. The radio signal receiver and device alarm are also subcomponents of the second component. The control subcomponent may control the activation/deactivation of the first component. In another embodiment, the control subcomponent of the second component may control the radio frequency emitted from the first component. It may also control the effective range of the signal emitted from the first component.

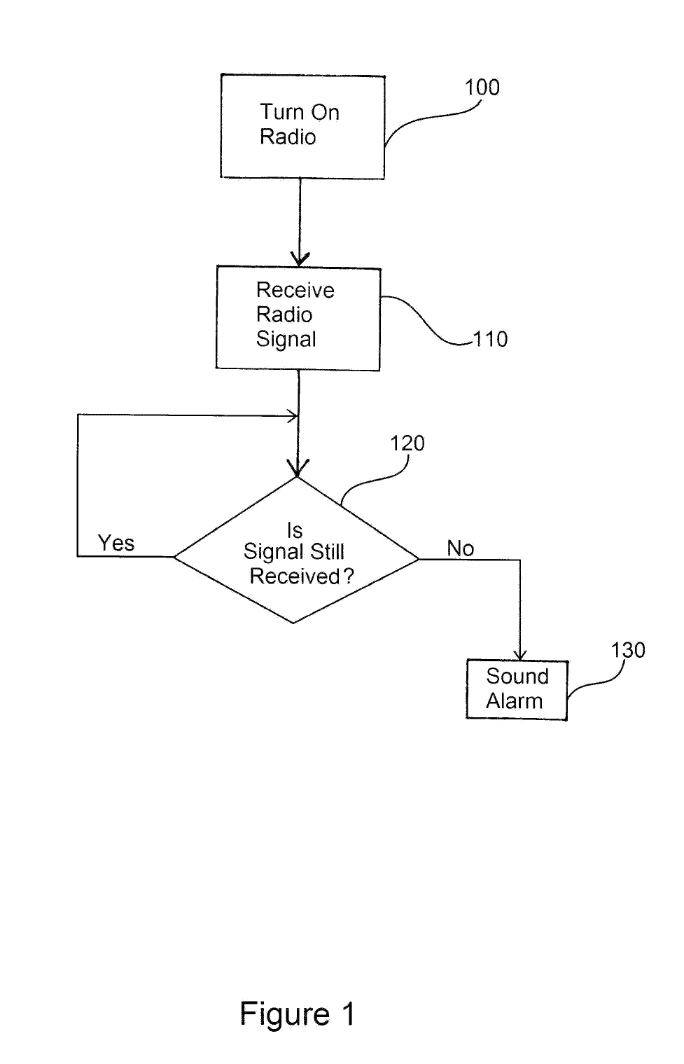

FIG. 1 illustrates the interface between the second component control subcomponent and the radio signal receiver subcomponent and the alarm subcomponent. In the embodiment illustrated in FIG. 1, the system is initiated by turning on the first component 100. It will be appreciated that system activation is not dependent upon a seat belt or harness being latched together. Such mechanisms can be prone to breaking or disrepair thus jeopardizing the entire system. In one embodiment, the first component does not need to be attached to child seat or seat belt. In one embodiment, positioning of the first component on the seat buckle can make it easier for the passenger to inadvertently turn the component off. In one embodiment, a radio transmitter on/off switch is contained in both the first and second component. In another embodiment, the first component is activated by a switch on the second component. This eliminates the possibility of the passenger inadvertently turning off the alarm system. In one embodiment, the second component would send a radio signal to the first component. This second component radio signal would serve as the on switch for the first component and the transmission of it radio signal. (System initiation is also not be dependent upon the car ignition switch being turned on.)

A radio signal is broadcast from the first component. The radio signal is received by the receiver in the second component 110. It will be appreciated that the first component may be located in the back seat of a car and the second component may be suspended from the key ring inserted in the car ignition. The distance between the first and second component is typically less than 6 feet. It will be appreciated that in one embodiment, the first component comprises a rough or shaped surface to hinder the second component from sliding off the car seat.

In another embodiment, the first component may be placed on an object such as a laptop computer, tablet computer. The first component may be placed on or proximate to any other object to be monitored by the custodian. It will be appreciated that the custodian may be a infant's parent or other responsible individual. The custodian may be the car driver. The object monitored may be an infant, child, disabled person, elderly person (hereinafter “passenger”) or an object. The object monitored may also be a pet or animal such as a police dog or rescue dog. The passenger, object or animal may be referred to as an “object”

In one embodiment, the first component emits a constant radio signal which is continuously received by the second component. The control subcomponent monitors the receiver to detect that the radio signal is being received 120. If the radio signal is received, the control subcomponent programmed subcomponent goes through a loop to inquire again if the signal is being received.

If the control subcomponent detects that the radio signal has not been received by the receiver of the second component, the control subcomponent activates the alarm 130. It is intended that the alarm is an audible noise that can be easily perceived by the custodian. The second component may be programmed to allow for several missed signals from the first component without sounding an alarm.

In one embodiment, the alarm may be modified to emit a chirping sound or other audible sound to notify the driver that the radio signal received has become weak. This would require the control subcomponent to be appropriately programmed. It would also require modification of the alarm mechanism to allow it to emit two separate categories of sound, e.g., a chirping sound in response to a weak signal and a full alarm sound when receipt of the signal was interrupted. The chirping sound may be activated by low battery power in the first component or in the second component. In another embodiment, low battery may be indicated by a light on either the first or second component. In another embodiment, the alarm may include lights on the second component. The light alarm component may be in addition to or in lieu of the audio alarm component.

In another embodiment, the second component may be equipped with an alarm deactivation switch.

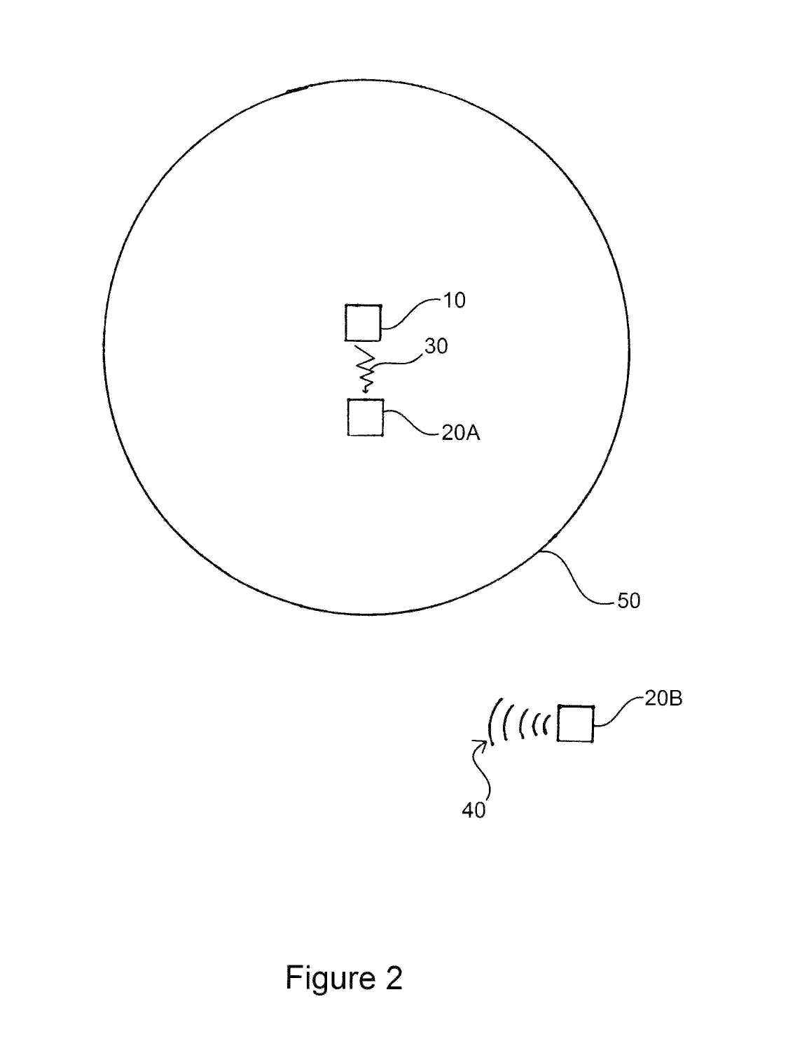

FIG. 2 illustrates the spatial relationship between the first component and the second component significant to the operation of the disclosure. The first component 10 occupies the center of a circle 50. The circle represents the effective range of the radio signal transmitter located within the housing of the first component. Also illustrated is a second component 20A located proximate to the first component and within the effective range of the radio signal. The transmission of a radio signal from the first component to the second component is also illustrated 30. The second component within the range of the first component radio signal does not activate an alarm. See FIG. 1.

FIG. 2 also illustrates the second component located a distance away from the first component and outside the effective range of the radio transmitter. In this situation, the radio signal receiver of the second component does not receive a signal. The control unit detects that the signal has been interrupted and the alarm 40 is sounded. In another embodiment, the alarm can be the illumination of a light or a vibration device in the second component.

The alarm being sounded alerts the custodian that a person, e.g., infant, or object remains in the car. It will be appreciated that the driver may properly exit the car by first turning off the car ignition, deactivating the first component, and removing the infant from the car seat. Deactivating the first component may also turns off the second component. It will be appreciated that requiring deactivation of the system by turning off the first component requires the custodian to access the rear seat and thereby be in proximity to the person, object or animal. This facilitates the custodian to remember to take the person or object. In one embodiment, the first component may be contained in the animal collar.

This specification is to be construed as illustrative only and is for the purpose of teaching those skilled in the art the manner of carrying out the invention. It is to be understood that the forms of the disclosure herein shown and described are to be taken as the presently preferred embodiments. As already stated, various changes may be made in the shape, size and arrangement of components or adjustments made in the steps of the method without departing from the scope of this disclosure. For example, equivalent elements may be substituted for those illustrated and described herein and certain features of the disclosure maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

What I claim is:

1. A method for alerting a custodian that an object, passenger or animal has been left unattended comprising the steps of:
a) activating a radio signal transmitted by a first component;
b) a second component receiving the radio signal;
c) interrupting the receipt of the radio signal by the second component by moving the second component away from the first component; and
d) activating an alarm in the second component.

2. The method of claim 1 further comprising activating the first component by a radio signal from the second component.

3. The method of claim 1 wherein the object, passenger or animal is left unattended in a car.

4. The method of claim 1 wherein the object, passenger or animal is left unattended in a shopping cart.

5. The method of claim 1 further comprising
a) programming the radio signal transmitter of the first component to send a signal at a specified interval; and
b) programming a control subcomponent of the second component to not interpret breaks in signal of the specified interval as an interruption triggering an alarm.

6. The method of claim 1 further comprising placing a passenger, object or animal in a car.

7. The method of claim 4 further comprising attaching the first component to the passenger, object or animal.

8. The method of claim 4 further comprising placing the first component on seat next to the passenger, object or animal.

9. An apparatus for monitoring the presence of a passenger, object or animal within a predetermined distance of a custodian comprising:
a) a first component radio signal transmitter attached to or placed proximate to a monitored passenger, object or animal;
b) a second component signal receiver to receive signals from the signal transmitter;
c) an alarm subcomponent contained with the second component signal receiver; and
d) an alarm activator activated by non-predetermined interruptions in the signal received from the first component signal transmitter to the second component signal receiver.

10. The signal receiver of claim 9 further comprising a housing.

11. The signal receiver housing of claim 10 further comprising a housing attachable to a key chain ring.

12. The signal receiver housing of claim 10 further comprising the alarm and alarm activator.

13. The signal transmitter of claim 9 comprising an outer covering removably attachable to a child automobile safety seat.

14. An apparatus for monitoring the presence of an object within a predetermined distance of a custodian comprising:
a) a first component comprising a battery operated radio signal transmitter with a predetermined range;
b) a second component comprising a battery operated radio signal receiver wherein radio signals from the first component are received by the second component within the predetermined range;

15. The apparatus of claim 14 further comprising an activation switch on the first component controlling the transmission the radio signal.

16. The apparatus of claim 14 further comprising a control activation switch that allows the radio transmission range to be varied.

17. The apparatus of claim 14 further comprising a control activation switch on the second component control the transmission of radio signal from the first component.

18. The apparatus of claim 14 further comprising the first component attached to an animal collar.

19. The apparatus of claim 14 further comprising the first component as a wrist bracelet.
